(19) United States
(12) Patent Application Publication
(10) Pub. No.: US 2009/0297923 A1
(43) Pub. Date: Dec. 3, 2009

(54) SOL-GEL DERIVED HIGH PERFORMANCE CATALYST THIN FILMS FOR SENSORS, OXYGEN SEPARATION DEVICES, AND SOLID OXIDE FUEL CELLS

(76) Inventors: Monika Backhaus-Ricoult, Horseheads, NY (US); Yunfeng Gu, Painted Post, NY (US)

Correspondence Address: CORNING INCORPORATED, SP-TI-3-1, CORNING, NY, 14831, US

(21) Appl. No.: 12/128,080

(22) Filed: May 28, 2008

(51) Int. Cl. H01M 4/90; H01M 4/88; B01J 23/745

(52) U.S. Cl. 429/41; 502/101; 502/303

(57) ABSTRACT

A method of forming a sol-gel derived catalyst thin film on an electrolyte substrate includes forming a cathode precursor sol and/or composite cathode slurry, depositing the cathode precursor sol or slurry on the electrolyte and drying the deposited film to form a green film, and heating the green film to form a sol-gel derived catalyst thin film. An electrochemical cell such as a solid oxide fuel cell can include the sol-gel derived catalyst thin film.

### BACKGROUND AND SUMMARY OF THE INVENTION

The present invention relates to electrochemical cells and more specifically to electrochemical cells comprising sol-gel derived catalyst thin films that, in combination with a yttria-stabilized zirconium oxide electrolyte, exhibit extremely high oxygen incorporation rates and cell performance compared to conventional electrochemical cells.

Electrochemical cells can be used in a variety of applications including solid oxide fuel cells, sensors, electrochemical oxygen separation devices, and water splitting cells. For example, solid oxide fuel cells (SOFCs) have attracted interest as a source for pollution-free power generation whereby electrical energy can be produced from the chemical energy available in fuels such as hydrogen, hydrocarbons and fossil fuels.

Such electrochemical cells typically comprise an oxygen ion electrolyte, an oxide cathode and an anode. For example, a typical SOFC comprises a dense oxygen ion conducting electrolyte that is sandwiched between a porous air electrode (cathode) and a porous fuel electrode (anode). In operation, electrical energy is produced by electrochemical combination of the fuel with an oxidant.

As a further example, electrochemical sensors comprising an oxygen ion electrolyte and oxide electrodes can be used for the detection of gases such as O₂, CO, CO₂ and NOₓ. The electrochemical sensors use modifications in electrode impedance, current-voltage characteristics, or response behavior to voltage modulations to identify and quantify the levels of target gases.

Gas separation by electrochemical oxide membranes advantageously involves a high oxygen flux at low applied voltages, which can be achieved by high performance cathodes demonstrating low resistance to oxygen incorporation.

Electrolyte performance is an important factor in designing high performance electrochemical cells, particularly solid oxide fuel cells. Yttria-stabilized zirconium oxide (YSZ) is a commonly-used electrolyte material due to its mechanical, electrical, chemical and thermal properties. Both cubic (8YSZ) and tetragonal (3YSZ) polymorphs are used. Cubic YSZ offers higher ionic conductivity and lower strain tolerance, while tetragonal YSZ provides higher strength at comparably lower (approximately 30%) oxygen ion conductivity. Due to its relatively high strain tolerance, tetragonal YSZ may be advantageously used in SOFC applications as relatively thin (˜20 micrometer) electrolyte sheets. Solid oxide fuel cells typically operate at elevated temperatures, usually between 700 and 1,000° C.

The choice of electrode is also a key factor in designing a successful electrochemical cell. Electrode materials for an electrochemical sensor, for example, preferably exhibit a variety of properties including high detection signal intensity, rapid response and a selective response to target gases via chemical interactions, which can include adsorption, absorption and redox processes.

In most commercial and prototype SOFCs, the anode is made of a nickel-YSZ cermet, while the cathode is made of doped or un-doped lanthanum manganite, lanthanum ferrite or lanthanum cobaltite, or a solid solution thereof. For example, lanthanum manganite and lanthanum ferrite can be doped with strontium to form strontium doped lanthanum manganite (LSM) and strontium doped lanthanum ferrite (LSF).

During SOFC operation, oxygen from the gas phase (cathode side) is incorporated into the electrolyte in form of oxygen ions. The oxygen ions migrate via the cathode through the electrolyte to the anode where they react with a fuel such as hydrogen. Electrons that are produced via this process are made available to an external circuit to provide usable power.

Depending on the choice of cathode, oxygen incorporation at the cathode can occur via a number of different mechanisms such as adsorption, diffusion, dissociation, charge transfer and exchange with oxygen vacancies. Each of the foregoing contribute to the cathode resistance, and for different cathode materials, the rate limiting step for oxygen incorporation can differ.

For example, LSM is a mixed ionic-electronic conductor (MIEC). However, LSM has relatively low ionic conductivity. As a result, in cells having an LSM cathode, oxygen incorporation occurs principally via triple phase boundaries, which are the contact points between the electron-conducting LSM, the ion-conducting electrolyte, and the gas phase. Even in a LSM/YSZ composite cathode, due to the limited number of triple phase boundary sites, charge transfer at the triple phase boundary is rate-controlling at high temperature. In order to increase the reaction zone beyond the triple phase boundaries, it is preferred that the cathode conducts electrons as well as oxygen ions.

Lanthanum strontium ferrite (LSF) is a mixed ionic-electronic conductor (MIEC). Mixed conductor electrodes allow additional oxygen incorporation from the gas into the mixed conductor at the electrode surface, and then oxygen ion transport through the mixed conductor to the electrolyte interface, where the oxygen is incorporated into the electrolyte. For mixed conductor electrodes, the rate limiting steps are usually oxygen incorporation at the electrode-gas interface and diffusional transport of oxygen ions through the electrode material.

Irrespective of the differences in oxygen incorporation and/or transport mechanisms for LSM (ionic conductor) and LSF-based (mixed conductor) cathodes or, more generally, for oxides with different conduction contributions, the surface chemistry of electrolyte/oxide interfaces (triple phase boundaries) or the electrode oxide itself play an important role in the overall exchange rates of oxygen and can strongly impact the cathode polarization.

In addition to SOFCs, zirconia-based sensors and electrochemical oxygen separation devices are similarly assembled with electrolyte, cathode and counter electrode. Application of a cell voltage induces the pumping of oxygen through the cell. The operating voltage of single-cell devices composed of YSZ electrolyte, cathode and counter electrode (or anode) is usually reduced compared to the theoretical open circuit voltage due to electrode polarization.

Cathodes for electrochemical cells such as SOFCs, sensors, oxygen separation devices, etc. are often obtained using traditional powder-based processing methods, where oxide powders are applied to the electrolyte by processes such as screen printing, jet printing, paint brushing, spinning, etc. After the application step, the powders are fired at a high temperature to form a porous cathode structure. As a result of the high heating temperature, however, significant grain growth can occur resulting in final grain sizes of at least several hundred nanometers, even in the case of very small initial particle sizes.

In addition to grain growth, the multiple phases in composite cathodes may undergo interdiffusion and chemical reactions at their contact points. As a result, both external and internal surfaces may be adversely affected by the undesired segregation of impurities and intrinsic components. By way of example, segregation of strontium oxide to the surface may occur in perovskites, which can have a deleterious effect on cathode oxygen exchange rates. In a similar vein, segregation of impurities such as alumina and silica may increasingly occur at higher temperatures (especially above 900° C.), which can disadvantageously decrease oxygen exchange rates.

In view of the foregoing, it would be advantageous to provide a cost-effective process for forming electrochemical cells and particularly the electrochemical cell cathode that avoids the undesirable consequences associated with conventional, elevated temperature processes.

One aspect of the invention relates to the formation of high performance catalyst thin films using a low cost, low temperature sol-gel technique. A further aspect of the invention relates to electrochemical cells comprising thin film cathodes that include a sol-gel derived thin film. Preferred applications for the inventive electrochemical cells with sol-gel derived high performance cathodes include YSZ electrolyte-based SOFCs, sensors, electrochemical oxygen separation membranes and water splitting devices.

The high performance of the inventive electrochemical cells is based on very high oxygen exchange rates at the thin film cathode surface and on rapid diffusion through the thin film cathode. Advantageously, a low heating temperature and slow decomposition of the sol-gel precursor produce a thin film (<1 micrometer) having small grain size (30-100 nm), as well as low intrinsic and impurity segregation. The inventive processing and the resulting microstructure facilitate the high oxygen exchange rate.

In traditional screen-printed MIEC cathodes such as LSF-based cathodes or LSF/YSZ composite cathodes, there are two main contributions to cathode polarization: (i) a low oxygen incorporation rate from the gas phase into the cathode material at the cathode surface, and (ii) slow diffusion of oxygen ions and electrons from the MIEC surface to the cathode/electrolyte interface. Even for porous films, the characteristic diffusion length for a traditional screen-printed cathode is in the range of 1-2 micrometers.

However, in the case of sol-gel derived pure LSF or LSF/3YSZ composite thin film cathodes, which involve bulk and grain boundary diffusional transport of electrons and oxygen ions over a film thickness of less than a micrometer, the diffusion resistance is significantly reduced compared to a traditional cathode. The thin film cathode offers the additional advantages of faster heat up due to its lower thermal mass and a higher thermal shock resistance during temperature cycling.

Notably, oxygen incorporation from the gas phase into sol-gel derived LSF cathodes is easier than in traditional screen-printed cathodes because the sol-gel derived cathode film surface is more active due to a lower temperature heating, reduced segregation, and a higher chemical surface activity. Further, the contribution of grain boundary (intergrain) transport relative to that by transport through the grain (intragrain) can be significantly enhanced due to a small grain size.

A further advantage of sol-gel derived cathodes compared to screen-printed cathodes is the flexibility in the process. Because the film precursor solution can be applied to shaped as well as flat surfaces, the cathode can be formed on curved surfaces, or on the inside of tubes or honeycombs.

These and other aspects and advantages of the invention compared to conventional electrochemical cell formation processes are summarized below:

Low cost raw materials—thin film precursor material is derived from readily-available metal nitrates, glycols, and acids;

Ease of processing—precursor paste/slurry is readily obtainable, and the application thereof onto an electrolyte substrate can be performed using simple processes such as spraying, brushing, or spinning;

Flexibility of processing—the precursor sol can be applied to curved as well as flat surfaces, within channels and/or onto porous substrates;

Low heating cost—the cathode can be formed from the precursor sol/slurry at low temperature;

Higher thermal shock resistance—thin film dimensions of the cathode result in lower internal stresses;

Rapid start up and shut down of cells—cells can be heated rapidly to elevated temperatures due to their low thermal mass and high thermal shock resistance;

Improved device performance—higher cathode activity results in faster oxygen incorporation into the cathode, which directly impacts cell performance.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention and together with the description serve to explain the principles and operations of the invention.

### BRIEF DESCRIPTION OF THE DRAWINGS

FIG. 1 is a powder X-ray diffraction pattern for sol-gel derived LSF heated at 800° C.;

FIG. 2 is a plot of TG-DTG results for a dried LSF gel prepared according to the present invention;

FIG. 3a is an SEM micrograph depicting the characteristic microstructure of a sol-gel derive cathode according to the present invention;

FIG. 3b is an SEM micrograph depicting a typical microstructure of a screen-printed LSF/3YSZ cathode according to the prior art;

FIG. 4 is plot of impedance spectra for symmetric single-cell devices with inventive sol-gel derived electrodes and comparative screen-printed electrodes;

FIG. 5 is a plot of impedance spectra for symmetric single-cell devices with inventive sol-gel derived electrodes;

FIG. 6a is a logarithmic plot of cathode overall resistance as function of 1/T. The data are for cathodes according to the invention, as well as a comparative screen-printed LSF/3YSZ cathode;

FIG. 6b is a logarithmic plot of cathode main resistance as function of 1/T. The data are for cathodes according to the invention, as well as a comparative screen-printed LSF/3YSZ cathode;

FIG. 7 is a plot of impedance spectra for oxygen pump cells at approximately 750° C. The plot includes data for sol-gel derived cathodes (inventive) and screen-printed electrodes (comparative);

FIG. 8 is a plot of impedance spectra for inventive oxygen pump cells at approximately 800° C. in air;

FIG. 9 is a plot of current density versus applied voltage at 750° C. in air for different single-cell devices with cathodes according to the present invention. A current density measurement for a screen-printed LSM/3YSZ sample is shown for comparison.

### DETAILED DESCRIPTION OF THE PREFERRED EMBODIMENTS

The invention relates generally to methods for forming a sol-gel derived catalyst thin film such as a thin film that can be incorporated into an electrochemical cell. The invention also relates to a cathode assembly for an electrochemical cell comprising a continuous or discontinuous sol-gel derived catalyst thin film. The sol-gel derived catalyst thin film is preferably formed on an electrolyte substrate such that the thin film has an average thickness of less than about 1 micrometer, and an average grain size of less than about 100 nm.

According to one embodiment, a method of forming a sol-gel derived catalyst thin film comprises (i) forming a sol gel film on an electrolyte substrate; (ii) drying the sol gel film to form a green film; and (iii) heating the green film to form a catalyst thin film on the substrate.

One method of forming the cathode precursor sol is a modified Pechini method. The raw materials used in this synthesis include metal nitrates, citric acid and ethylene glycol. The citric acid and ethylene glycol are preferred polymerization or complexation agents for the process. The metal nitrates preferably include soluble nitrates of lanthanum, strontium and iron. In addition to the lanthanum, strontium and iron-bearing nitrates, salts of alkaline earth, rare earth or other transition metal elements can be included.

According to a preferred method, analytical reagent grade metal nitrates are dissolved in de-ionized water at 60° C. under stirring. After complete dissolution of the nitrates, citric acid and ethylene glycol are added. Upon heating to about 85° C., and after removal of water and other volatile materials, a viscous polymeric sol (precursor sol) is formed.

If desired, the precursor sol can be used to synthesize a cathode precursor composite slurry by mixing the precursor sol with a yttrium stabilized zirconia powder. Prior to being mixed with the sol, the zirconia powder is preferably dispersed in ethylene glycol by ultrasonic treatment. The mixture of sol and zirconia powder is then treated by ultrasonication to obtain a homogeneous composite slurry. The viscosity and/or concentration of the cathode precursor sol or composite slurry can be controlled by varying the initial concentration(s) of the reactant(s) or, after formation, by heating the sol/slurry in order to remove water and other volatile materials.

A thin film cathode can be formed by depositing a layer of the cathode precursor sol or composite slurry on a surface of a dense electrolyte, and then drying and heating the coated electrolyte. Preferably, prior to deposition of the sol or slurry, the surface of the electrolyte is acid-cleaned to activate the electrolyte surface. A thin layer of the cathode precursor sol or composite slurry can be applied on the electrolyte surface by different coating methods, such as spin-coating, spray-coating, screen-printing or tape casting.

According to one embodiment, the coated electrolyte is dried at room temperature, heated in a two-stage heating cycle, and then cooled to room temperature to form a crystalline catalyst thin film. By way of example, after room temperature drying of the deposited cathode layer, the coated electrolyte is heated to 500° C. at a heating rate of 30° C./hr, held at 500° C. for 0.5 hr, further heated to 800° C. at a heating rate of 60° C./hr, held at 800° C. for 1 hr, and then cooled to room temperature at a cooling rate of 120° C./hr. This heating profile is defined as heating cycle 1 (slow heating and slow decomposition). According to a further embodiment, after room temperature drying of the deposited cathode layer, the coated electrolyte is heated in a one-stage heating cycle directly to 800° C. at a heating rate of 100° C./hr and, after holding at 800° C. for 1 hr, cooled to room temperature. This heating profile is defined as heating cycle 2 (rapid heating).

Referring to heating cycle 1, while a preferred initial temperature is 500° C., the initial temperature can range from about 300° C. to 700° C. (e.g., 300, 350, 400, 450, 500, 550, 600, 650 or 700° C.). Similarly, while a preferred final temperature in the two-stage heating cycle is 800° C., the final temperature can range from about 300° C. to 900° C. (e.g., 300, 350, 400, 450, 500, 550, 600, 650, 700, 750, 800, 850 or 900° C.). If a one-stage heating cycle is used, a preferred temperature is from about 300° C. to 900° C. In both heating cycle 1 and heating cycle 2, the heating and cooling rates can range from 10° C./hr to 200° C./hr and, depending on other processing conditions, the hold times can range from 0.1 hr to 5 hr.

Preferably, the cathode precursor sol comprises lanthanum strontium ferrite (LSF). Because strontium can be substituted for lanthanum over the entire stoichiometric range, the LSF composition can vary according to the formula LaₓSr₁₋ₓFeO₃ (0<x<1). Also, as disclosed above, because additional metal salts can be incorporated into the sol-gel synthesis, additional dopants can readily be incorporated into the catalyst (oxide) film.

### EXAMPLES

The invention will be further clarified by the following examples.

A polymeric sol having the composition La_{0.8}Sr_{0.2}FeO₃ was prepared according to the following process. The primary precursors were analytically pure (99.9%, Alfa Aesar) metal nitrates. As disclosed above, citric acid and ethylene glycol were used as polymerization/complexation agents.

Initially, 150 ml de-ionized water was filled into a 1000 ml flask and heated to 60° C. Lanthanum nitrate hexahydrate (0.08 mol, 34.64 g), strontium nitrate (0.02 mol, 2.48 g), and iron (III) nitrate nonahydrate (0.10 mol, 40.4 g) were dissolved in the heated de-ionized water with stirring. After complete dissolution of the added salts, citric acid (0.6 mol, 115.27 g) (Alfa Aesar) and ethylene glycol (0.9 mol, 55.84 g) (Fisher) were added to the flask. The molar ratio of citric acid to total metal ions was 3, and the molar ratio of ethylene glycol to citric acid was 1.5. The mixture was heated to 85° C. in order to remove water and other volatile matter. The final volume of the viscous liquid LSF polymeric sol was about 400 ml.

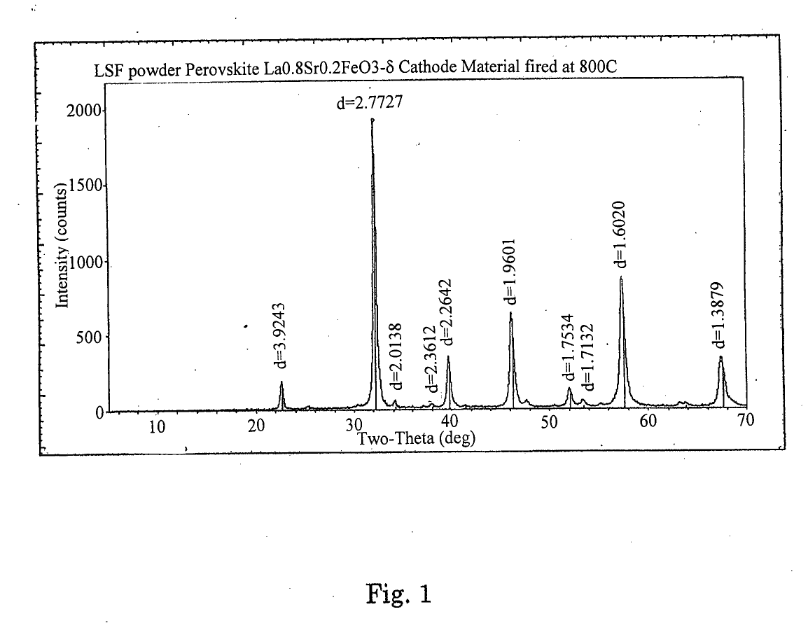

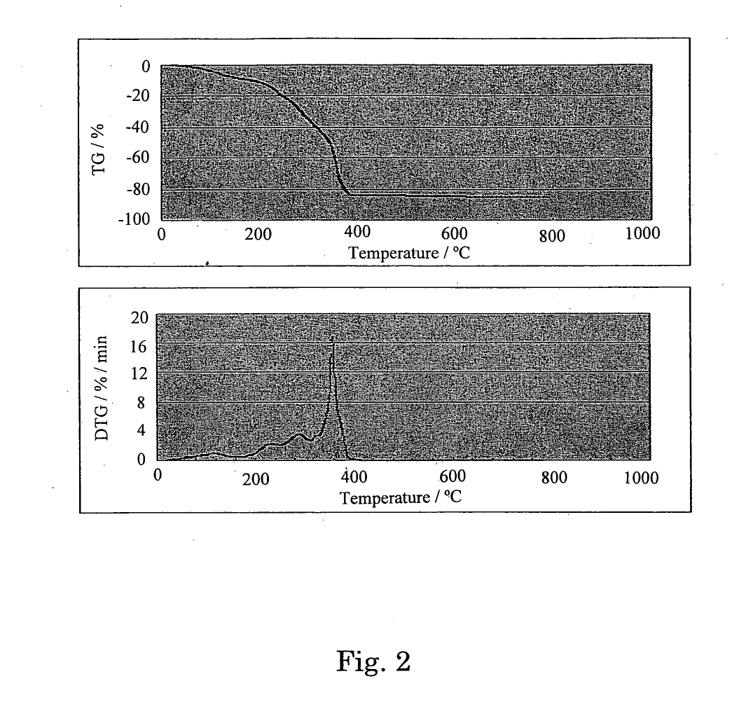

For analysis, the LSF polymeric sol was dried, heated to 800° C. and ground into fine powder. As shown in FIG. 1, the XRD analysis indicates that the sol-gel derived LSF powder is a pure perovskite phase. The powder has orthorhombic structure with lattice constants, a=0.55677 nm, b=0.55532 nm and c=0.78459 nm. The crystallite size was calculated to be approximately 25 nm. As shown in FIG. 2, thermogravimetric analysis indicated that the exothermic reaction occurred over the range 314-365° C., while all reactions were completed by 400-450° C. For the TG-DTG measurement, the gel was heated in air to 900° C. at a heating rate of 10° C./min. The total weight loss was around 85%.

The foregoing LSF polymeric sol was used to prepare a LSF/YSZ composite slurry by mixing commercial 3YSZ power (Tosoh Cop.) with the LSF sol. In order to synthesize a homogeneously dispersed composite slurry, the YSZ powder was initially dispersed in ethylene glycol. By way of example, 1 g of YSZ powder was added to 10 g ethylene glycol and dispersed by ultrasonic treatment for 10 min. The dispersed YSZ powder was then mixed with the LSF sol.

Composite slurries having different volume ratios of LSF/YSZ can be prepared. For instance, a composite slurry having a LSF/YSZ ratio of 2 was prepared by mixing 0.446 g dispersed YSZ powder with 3.457 g of LSF sol, and a composite slurry having a LSF/YSZ ratio of 1 was prepared by mixing 1.673 g dispersed YSZ powder with 3.451 g of LSF sol. In order to form a homogeneous composite slurry, each of the LSF/YSZ mixtures was ultrasonicated for an additional 10 min. A composite slurry according to the invention can have a LSF/YSZ ratio of between about 0.1 and 10 (e.g., 0.1, 0.2, 0.4, 0.8, 1, 2, 4, 8 or 10).

The sol-gel derived cathodes according to the present invention can consist essentially of lanthanum strontium ferrite or a mixture of lanthanum strontium ferrite and yttria-stabilized zirconia (e.g., a homogenous mixture of lanthanum strontium ferrite and yttria-stabilized zirconia). Both the pure LSF sol and the aforementioned LSF/YSZ composite slurries were used to form cathodes on YSZ electrolytes. While the following description discloses the formation of an LSF-based cathode, the LSF/YSZ composite cathodes were prepared by using the same procedure using the concentrated LSF/YSZ slurries.

A thin 3YSZ sheet (approximate thickness 20 micrometers) was used as the electrolyte substrate for both the inventive structures disclosed herein, as well as for comparative devices comprising screen-printed cathodes. Tosoh 3YSZ powder (TZ-3Y) was used as the raw material for the electrolyte. A castable mixture was obtained by mixing 3YSZ powder with milling media, flocculent, plasticizer and binder. The resulting slip was cast into a green tape on a support film, released from the support layer, and heated in a box furnace in air on setters. The standard heating cycle for the electrolyte comprised heating the green tape to a maximum temperature of 1430° C. with a hold time of 2 hr to obtain a fully dense, 20 micrometer thick flexible sheet of tetragonal YSZ.

Prior to coating, the electrolyte surface was acid-washed with HF in order to activate the surface and promote bonding of the sol. The LSF sol was heated until it was fluid enough to flow, dispersed onto the center, and then spread over one side of the substrate. Typically, one drop of LSF sol was spread over an area of about 10 mm×10 mm. The coated electrolyte substrate was dried overnight at ambient temperature.

After drying, the coated electrolyte substrate was placed in a muffle furnace and heated to 500° C. at a ramp rate of 30° C./hr. The sample was maintained at 500° C. for 0.5 hr, and then heated to 800° C. at a ramp rate of 60° C./hr. The sample was maintained at 800° C. for 1 hr, and then cooled to room temperature at a rate of 120° C./hr (heating cycle 1).

Samples for electrochemical testing were obtained by coating both sides of a 2 inch×1 inch 3YSZ electrolyte sheet that was initially acid-washed. Concentrated LSF sol was dispersed onto the center of one side of the YSZ plate, and then spread over the electrolyte. One drop of LSF sol was typically spread over an area of about 15 mm×10 mm. The coated substrate was dried overnight at ambient temperature, and the LSF coating was then repeated on the opposite side of the electrolyte. The overlap of the coated areas on the two sides of the electrolyte, which is defined as the active electrode area, was approximately 10 mm×10 mm.

After drying, the coated electrolyte substrate was heated according to heating cycle 1 or heating cycle 2. A silver/palladium-based current collector was screen-printed on the oxide layers and heated to 800° C. for 2 h. By way of example, the current collector ink can include 60 vol. % metal (90 wt. % Ag:10 wt. % Pd) and 40 vol. % 3YSZ. The current collector thickness was typically 20-30 micrometers with very high porosity and large pore size.

For testing and monitoring the performance of the sol-gel derived cathodes, comparative cathode/cathode single-cell devices were used. In the single-cell devices, a thin sheet of 3YSZ electrolyte was sandwiched between two symmetric electrodes that were screen-printed (DeHaart screen printer) on both sides of the 3YSZ electrolyte and heated. The comparative electrodes include a screen-printed LSF/YSZ (40:60) oxide layer and a Ag(Pd)/YSZ current collector layer.

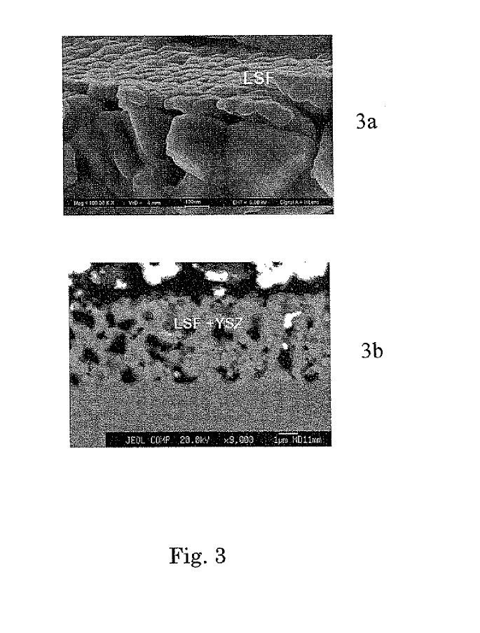

FIG. 3a is an SEM micrograph depicting the characteristic microstructure and dimensions of a sol-gel derive cathode according to the present invention, and FIG. 3b is an SEM micrograph depicting the characteristic microstructure of a conventional screen-printed LSF/3YSZ cathode. The advantage of the short diffusion distances in the sol-gel derived cathode is evident by the differences in dimensions. As shown in FIG. 3a, the grain diameter of the sol-gel derived film is approximately 100 nm, while the film has a minimum thickness of approximately 30 nm, which is substantially less than the electrode thickness that can typically be achieved by screen printing (typically 1 micrometer or greater) (see FIG. 3b).

The sol-gel derived cathode can range in average thickness from about 100 nm to 1 micrometer (e.g., 100, 200, 400, 600, 800 or 1000 nm). Preferably, the average thickness of the sol-gel derive cathode is less than about 1 micrometer, more preferably less than about 500 nm, most preferably less than about 100 nm. The sol-gel derived cathode can be a continuous or discontinuous film having crystalline grains ranging in size from about 30 to 100 micrometers. A discontinuous film may comprise thinner areas and/or areas where the electrolyte substrate is exposed. According to embodiments of the invention, the average crystalline grain size of the sol-gel derive cathode is less than about 100 micrometers, preferably less than about 50 micrometers.

Electrochemical testing was conducted in air and at low oxygen partial pressure on a Solartron impedance analyzer over the temperature range of 300° C.-800° C. Cathode impedance was measured in a symmetric two-electrode, four-wire set up. Impedance data were acquired with a Solartron system (1260 Frequency Response Analyzer/1287 Electrochemical Interface).

The cells were tested within a protective alumina tube in a tubular furnace under continuous gas flow. The active electrode area was 1 cm². The frequency was varied from 300000 Hz to 10 mHz. The amplitude applied between working and reference electrode was 30 mV. 10 points per decade of frequency were measured while scanning from the highest to the lowest frequency. Bulk, grain boundary and electrode contributions to the impedance were fitted by an equivalent circuit having a parallel resistor and constant phase element for each observed arc. Constant phase elements were used in the modeling instead of simple capacitors because these phase elements better describe the real system with its depressed arcs.

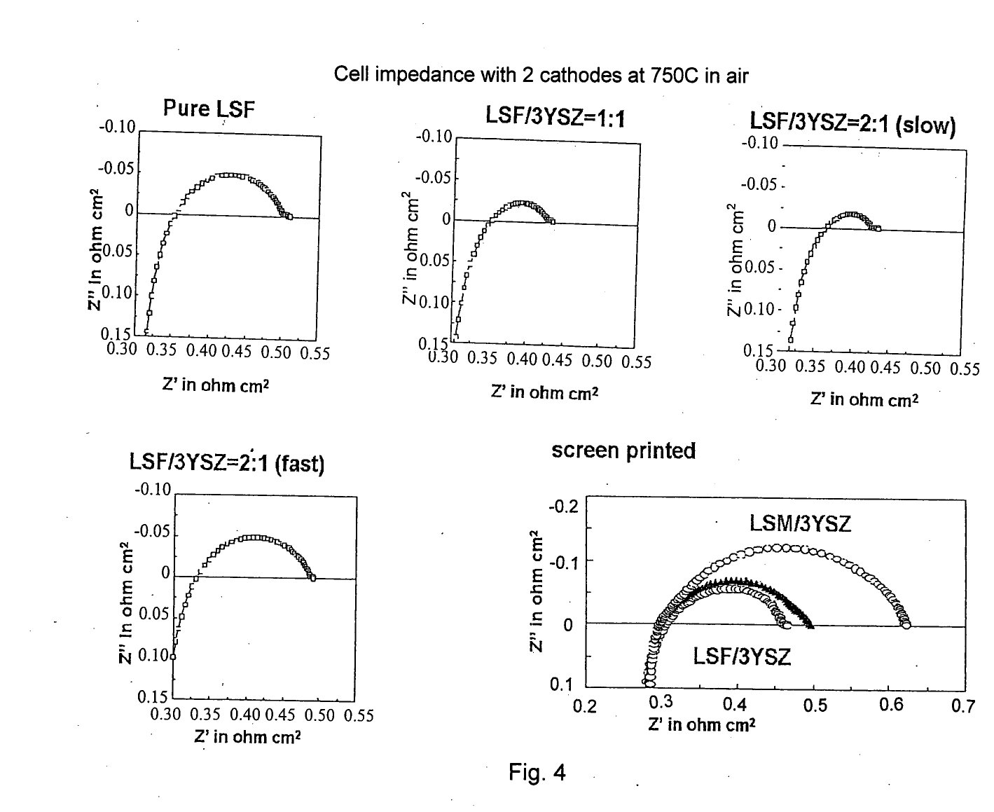

A summary of cathode characteristics for different sol-gel derived cathodes is shown in Table 1. The inventive data shown in Table 1 are for cathode pump cell samples having an approximately 20 micrometer thick 3YSZ electrolyte sheet, a symmetric oxide thin film on both sides of the substrate, and a coarse Ag(Pd)/3YSZ layer for current collection. Comparative results for a six micrometer thick screen-printed LSF/3YSZ (1:1) cathode are also shown. The main cathode resistance for the sol-gel derived cathode samples is substantially less than the main cathode resistance for the screen-printed samples. Selected data from Table 1 are plotted in FIGS. 4-9 and are discussed below.

In addition to illustrating the advantages of the sol-gel derived cathodes with respect to the screen-printed cathodes, the data also demonstrate that slow decomposition of the sol-gel precursor enhances performance. Advantageously, applicants have discovered that slow heating of a green precursor film to a relatively low temperature results in a catalyst film (sol-gel derived cathode) having improved catalyst activity. Without wishing to be bound by theory, the higher activity is believed to be the result of a thin film architecture (thickness less than 1 micrometer, preferably less than 0.5 micrometer), small grain size (d˜30-100 nm), low intrinsic and impurity segregation, and enhanced surface curvature of individual grains. This result cannot be achieved by the more rapid heating rates and higher temperatures used in conventional cathode film formation methods.

TABLE 1
Cathode characteristics for single-cell devices with sol-gel derived cathodes
(inventive) and screen-printed cathodes (comparative).
Pure LSF (heating cycle 1)

| | | | | | Secondary | |
|---|---|---|---|---|---|---|
| | Cathode overall | Electrolyte + | Main cathode | | cathode | Secondary |
| | resistance | contact | resistance | Main cathode | resistance | cathode |
| Temp. | [Ωcm²] | resistance | [Ωcm²] | capacitance | [Ωcm²] | capacitance |
| [° C.] | (=½ × cell) | [Ωcm²] | (=½ × cell) | [F] | (=½ × cell) | [F] |
| 750 | 0.075 | 0.35 | 0.070 | 1.7e−4 | 0.0045 | 5.9 |
| 700 | 0.173 | 0.47 | 0.173 | 8.5e−5 | | |
| 653 | 0.343 | 0.70 | 0.343 | 7.8e−5 | | |
| 605 | 0.69 | 1.17 | 0.69 | 7.2e−5 | | |
| 558 | 1.53 | 2.11 | 1.46 | 7.5e−5 | | |
| 510 | 3.96 | 5.03 | 3.84 | 1.5e−4 | | |
| 463 | 17.6 | 12.6 | 17.6 | 2.4e−4 | | |
| 410 | 30.4 | 34.9 | 30.4 | 1.2e−3 | | |

| | | | | | | |
|---|---|---|---|---|---|---|
| | | Electrolyte + | | | Secondary | Secondary |
| | Cathode overall | contact | Main cathode | Main cathode | cathode | cathode |
| Temp. | resistance | resistance | resistance | capacitance | resistance | capacitance |

LSF:3YSZ = 1:1 (heating cycle 1)

| | | | | | | |
|---|---|---|---|---|---|---|
| 794 | 0.015 | 0.26 | 0.008 | 2.50e−3 | 0.0046 | 7.18 |
| 750 | 0.04 | 0.35 | 0.038 | 2.9e−4 | 0.005 | 4.211 |
| 700 | 0.09 | 0.45 | 0.086 | 1.2e−4 | 0.005 | |
| 652 | 0.19 | 0.68 | 0.185 | 7.4e−5 | 0.008 | |
| 604 | 0.38 | 1.12 | 0.37 | 6.45e−5 | | |
| 557 | 0.94 | 2.01 | 0.88 | 6.07e−5 | | |
| 500 | 3.05 | 4.48 | 2.95 | 5.9e−4 | | |
| 450 | 23.7 | 11.7 | 23.0 | 5.2e−4 | | |
| 400 | 129 | 37.1 | 127 | 9.4e−4 | | |

LSF:3YSZ = 2:1 (heating cycle 1)

| | | | | | | |
|---|---|---|---|---|---|---|
| 794 | 0.0135 | 0.27 | 0.0067 | 3.4e−3 | 0.0065 | 11.3 |
| 750 | 0.0365 | 0.36 | 0.0315 | 3.5e−4 | 0.004 | 15.3 |
| 700 | 0.0778 | 0.47 | 0.073 | 1.4e−4 | 0.005 | 14.0 |
| 650 | 0.135 | 0.67 | 0.15 | 9.2e−5 | 0.005 | 15.0 |
| 600 | 0.307 | 1.11 | 0.29 | 8.0e−5 | 0.005 | 17.6 |
| 550 | 0.74 | 2.00 | 0.70 | 7.5e−5 | | |
| 500 | 3.13 | 4.86 | 2.96 | 1.5e−4 | | |
| 450 | 23.7 | 12.4 | 23.0 | 7.3e−4 | | |
| 400 | 20 | 12.4 | 23.0 | 7.3e−4 | | |

LSF:3YSZ = 2:1 (heating cycle 2)

| | | | | | | |
|---|---|---|---|---|---|---|
| 750 | 0.077 | 0.32 | 0.074 | 1.9e−4 | 0.004 | 3.8 |
| 700 | 0.143 | 0.46 | 0.143 | 9.5e−5 | 0.004 | |
| 650 | 0.246 | 0.71 | 0.246 | 8.6e−5 | | |
| 600 | 0.55 | 1.18 | 0.55 | 5.9e−5 | | |
| 550 | 1.2 | 2.87 | 1.17 | 1.1e−4 | | |
| 500 | 9.08 | 6.87 | 8.84 | 2.2e−4 | | |
| 450 | 75.7 | 20.2 | 75.5 | 5.7e−4 | | |

LSF:3YSZ = 1:1 (comparative) (heating cycle 1)

| | | | | | |
|---|---|---|---|---|---|
| 750 | 0.075 | 0.3 | 0.071 | 8.68e−4 | |
| 700 | 0.145 | 0.431 | 0.124 | 5.58e−4 | 0.02 |
| 650 | 0.3 | 0.644 | 0.2778 | 2.38e−4 | 0.04 |
| 600 | 1.165 | 1.116 | 0.649 | 1.20e−4 | 0.09 |
| 550 | 1.78 | 2.28 | 1.65 | 1.26e−4 | 0.13 |
| 500 | 5.81 | 5.62 | 5.398 | 1.96e−4 | 0.42 |
| 450 | 26.5 | 16 | 26.2 | 4.13e−4 | 0.8 |
| 400 | 273 | 80.8 | 213 | 3.69e−3 | 60 |

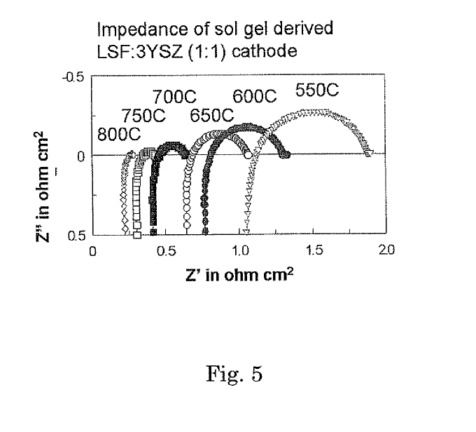

FIG. 4 shows impedance spectra for symmetric single-cell devices. The data include results for inventive sol-gel derived cathodes and comparative results from standard screen-printed LSF/3YSZ and LSM/3YSZ cells. Data are presented for cells operating at 750° C. in air, with cathode active areas of 1 cm² on each side of the electrolyte. FIG. 5 shows the temperature evolution of impedance for single-cell devices (LSF:3YSZ (1:1)) according to the present invention.

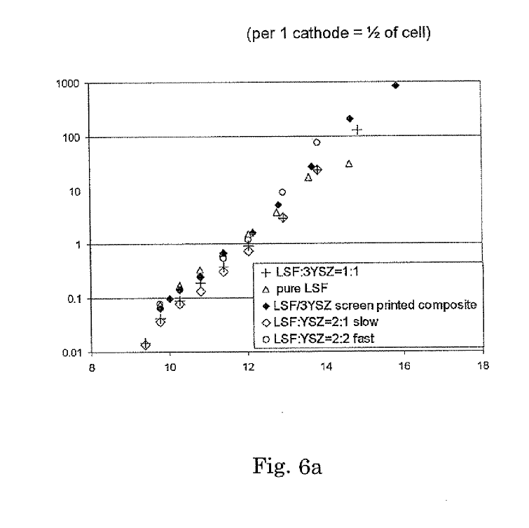

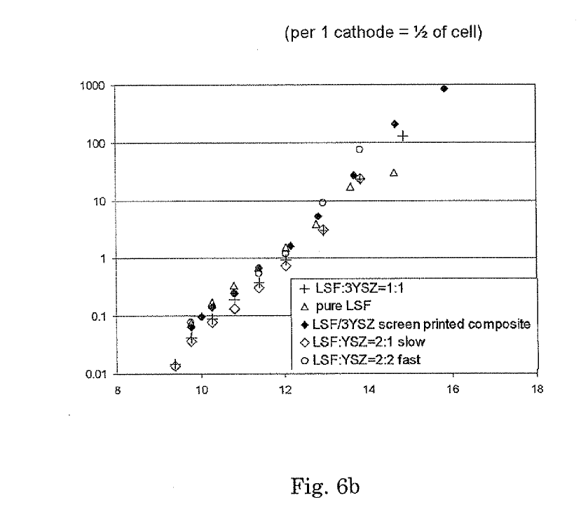

FIG. 6a shows the temperature dependence of the cathode overall resistance for sol-gel derived catalyst thin films according to the present invention. Data for screen-printed LSF/3YSZ cathodes are shown for comparison. The advantage of the slow heating during thermal decomposition of the sol-gel precursor is clearly visible. FIG. 6b shows the temperature dependence of the cathode main resistance for sol-gel derived catalyst thin films according to the present invention. As with FIG. 6a, data for screen-printed LSF/3YSZ cathodes are shown for comparison.

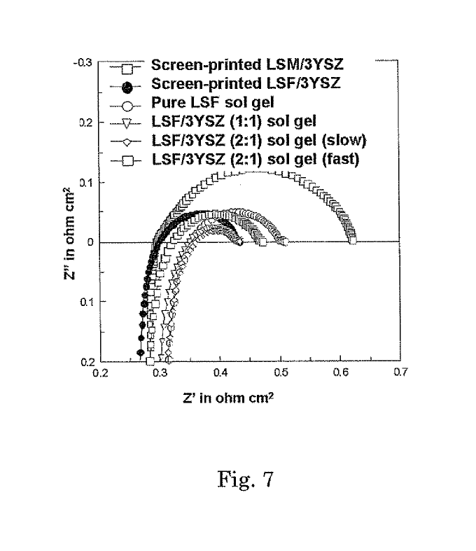

FIG. 7 is a plot of impedance spectra for single-cell devices (oxygen pump cells) comprising inventive sol-gel derived cathodes and comparative screen-printed cathodes at 750° C. in air. For the best sol-gel derived cathode, the cathode resistance is 1/10^{th} that of the resistance of the electrolyte, while for a conventional LSM/3YSZ screen-printed cathode, the cathode resistance is 5 times the resistance of the electrolyte.

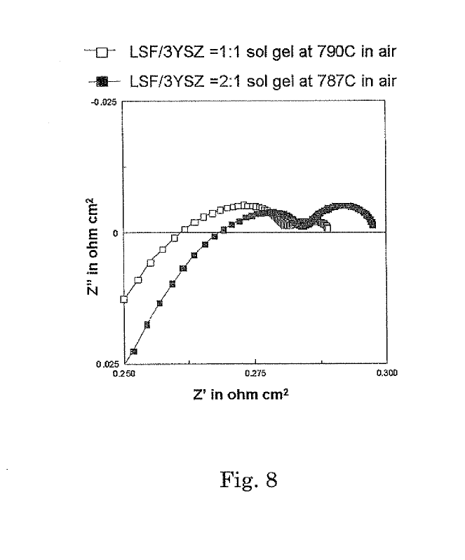

FIG. 8 is a plot of impedance spectra for single-cell devices with inventive cathodes at approximately 800° C. in air. At this temperature, the cathode impedance is negligible compared to the electrolyte resistance, and the cathode could be considered an ideal electrode with zero polarization resistance.

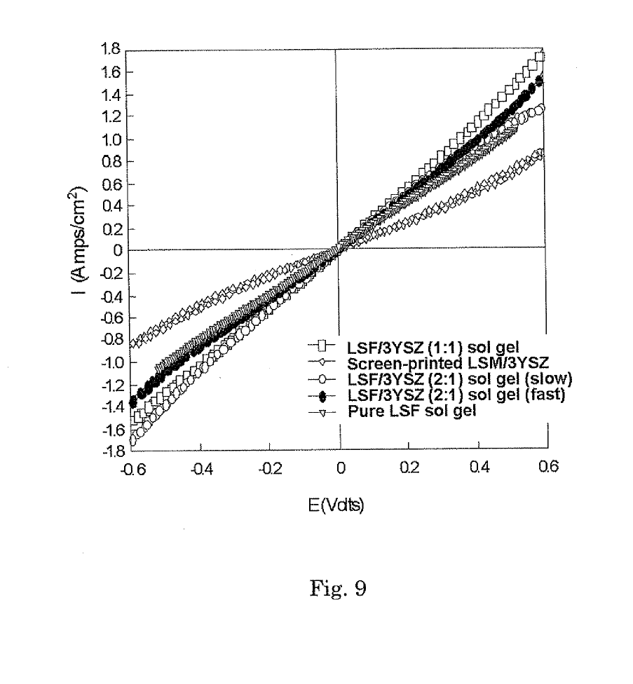

FIG. 9 is a plot of current density versus applied voltage at 750° C. in air for single-cell devices with different cathodes according to the present invention. A current density measurement for a cell with a screen-printed LSM/3YSZ cathode is shown for comparison.

It will be apparent to those skilled in the art that various modifications and variations can be made to the present invention without departing from the spirit and scope of the invention. Since modifications combinations, sub-combinations and variations of the disclosed embodiments incorporating the spirit and substance of the invention may occur to persons skilled in the art, the invention should be construed to include everything within the scope of the appended claims and their equivalents.

What is claimed is:

1. A method of forming a sol-gel derived catalyst thin film, comprising:
forming a sol gel film on an electrolyte substrate;
drying the sol gel film to form a green film; and
heating the green film to form a catalyst thin film on the substrate.

2. The method according to claim 1, wherein the electrolyte substrate comprises yttria-stabilized zirconium oxide.

3. The method according to claim 1, wherein the electrolyte substrate comprises 3YSZ.

4. The method according to claim 1, wherein the electrolyte substrate comprises 3YSZ and has a thickness of less than 25 micrometers.

5. The method according to claim 1, wherein the catalyst thin film comprises lanthanum strontium ferrite or a lanthanum strontium ferrite/yttria-stabilized zirconium oxide composite.

6. The method according to claim 1, wherein the catalyst thin film comprises La_{0.8}Sr_{0.2}FeO₃ or a mixture of La_{0.8}Sr_{0.2}FeO₃ and yttria-stabilized zirconium oxide.

7. The method according to claim 1, wherein the catalyst thin film is a perovskite crystalline film.

8. The method according to claim 1, wherein the catalyst thin film comprises crystalline grains ranging in average size from about 30 nm to 100 nm.

9. The method according to claim 1, wherein the catalyst thin film comprises crystalline grains having an average size of less than about 100 nm.

10. The method according to claim 1, wherein the catalyst thin film has an average thickness of between about 400 nm and 1 micrometer.

11. The method according to claim 1, wherein the catalyst thin film has an average thickness of less than about 1 micrometer.

12. The method according to claim 1, wherein the catalyst thin film is continuous.

13. The method according to claim 1, wherein the catalyst thin film is discontinuous.

14. The method according to claim 1, wherein the forming comprises:
forming an aqueous solution of a lanthanum nitrate, a strontium nitrate, and an iron nitrate;
adding at least one polymerization agent or a complexation agent selected from the group consisting of citric acid and ethylene glycol to the aqueous solution to form a precursor solution; and
heating the precursor solution to form a polymeric sol.

15. The method according to claim 14, wherein the polymeric sol is formed into the sol gel film on the electrolyte substrate by a method selected from the group consisting of spraying, brushing and spin-coating.

16. The method according to claim 14, wherein the forming further comprises:
mixing yttria-stabilized zirconium oxide powder with the precursor solution to form a mixture, and
heating the mixture to form a composite slurry.

17. The method according to claim 16, wherein the yttria-stabilized zirconium oxide powder comprises 3YSZ.

18. The method according to claim 16, wherein the composite slurry is formed into the sol gel film on the electrolyte substrate by a method selected from the group consisting of spraying, brushing and spin-coating.

19. The method according to claim 1, wherein the heating comprises:
heating the green film to a first temperature at a first heating rate; and
heating the green film to a second temperature greater than the first temperature at a second heating rate to form the catalyst thin film.

20. The method according to claim 1, wherein the first temperature is between about 300° C. and 700° C. and the second temperature is between about 300° C. and 900° C.

21. The method according to claim 1, wherein the first and second heating rates are between about 10° C./hr and 200° C./hr.

22. The method according to claim 1, wherein the first heating rate is less than about 30° C./hr and the second heating rate is less than about 50° C./hr.

23. The method according to claim 1, further comprising cooling the catalyst film to room temperature after heating to the second temperature.

24. The method according to claim 1, wherein the heating comprises:
heating the green film to a first temperature at a first heating rate to form the catalyst thin film.

25. The method according to claim 1, further comprising washing the electrolyte substrate with acid prior to forming the sol gel film on the electrolyte substrate.

26. The method according to claim 1, further comprising forming a current collector on the catalyst thin film.

27. An electrochemical cell comprising the sol-gel derived catalyst thin film according to claim 1.

28. A cathode assembly for an electrochemical cell comprising a continuous or discontinuous sol-gel derived catalyst thin film formed on an electrolyte substrate, wherein the sol-gel derived catalyst thin film has an average thickness of less than about 1 micrometer, and an average grain size of less than about 100 nm.
